(19) United States
(12) Patent Application Publication
(10) Pub. No.: US 2010/0106966 A1
(43) Pub. Date: Apr. 29, 2010

(54) Method and System for Registering and Verifying the Identity of Wireless Networks and Devices

(75) Inventors: Marc Santos, Surrey (CA); David Holmes, Burnaby (CA)

Correspondence Address: LARIVIERE, GRUBMAN & PAYNE, LLP, 19 UPPER RAGSDALE DRIVE, SUITE 200, MONTEREY, CA, 93940, US

(73) Assignee: 0856972 B.C. Ltd., Surrey, British Columbia (CA)

(21) Appl. No.: 12/526,484

(22) PCT Filed: Feb. 7, 2008
(86) PCT No.: PCT/CA08/00229

§ 371 Date: Oct. 22, 2009

Related U.S. Application Data
(60) Provisional application No. 60/899,885, filed on Feb. 7, 2007.

(51) Int. Cl. H04L 9/32; H04W 8/02; H04L 9/00

(52) U.S. Cl. 713/156; 370/328; 726/12

(57) ABSTRACT

The present invention discloses a method for registering a wireless network's identity using a central server. The central server receives a request for registration of an identifier of a wireless network. If the identifier has not been previously registered, the central server creates an association between the identifier and the wireless network, which is stored in a database maintained by the central server. The present invention also discloses a method for verifying a wireless network's identity by a wireless device. A central server comprising a database is provided, which registers an identifier of the wireless network. The central server receives from a wireless device an authentication request of the identifier. The authentication request arrives through a gateway of the wireless network. The central server then authenticates the identifier.

### FIELD OF THE INVENTION

The present invention relates to wireless network security. In particular, the invention relates to the use of digital certificates and the registration of network identifiers of wireless networks to authenticate wireless networks and wireless devices.

### BACKGROUND TO THE INVENTION

Wireless local area networks (WLAN) or wireless Internet service providers (WISP) are an increasingly popular method for networking and interconnecting wireless devices. Besides allowing the wireless devices on a WLAN to communicate wirelessly with each other, a WLAN can itself be connected to a wide area network (WAN), such as the Internet, thereby allowing the wireless devices to also communicate wirelessly with other devices on other networks. The ability of WLANs to allow users with wireless devices to transmit and send information wirelessly provides users with much greater flexibility and convenience than possible with traditional wired networks.

WLANs employ different protocols to communicate with wireless devices. Common protocols include Wi-Fi (based on IEEE 802.11 standards), WiMAX (based on IEEE 802.16 standards), and Global System for Mobile communications, or GSM.

Each WLAN typically has one or more identifiers to allow wireless devices connecting to the WLAN to know the identity of the WLAN. For wireless networks utilizing IEEE 802.11 protocols, one such identifier is the Service Set Identifier (SSID). The SSID is a code attached to all packets of data transmitted on a IEEE 802.11 WLAN to identify each packet as being part of that WLAN. All wireless devices attempting to communicate with each other on the WLAN must share the same SSID. An administrator of the WLAN can modify the SSID to be any alphanumeric code with a maximum length of 32 characters.

One consideration in implementing WLANs is the issue of security. It is important to ensure that information sent by or received from a wireless device in the WLAN is not accessed, modified, or otherwise intercepted by any unauthorized party. Related to this concern is the need to ensure that the WLAN a wireless device is connected to is in fact the WLAN the wireless device is intending to connect to, and not a rogue WLAN impersonating a legitimate WLAN. A wireless device that unwittingly connects to a rogue WLAN (instead of a legitimate WLAN) may expose any information sent by it to interception by the rogue WLAN. For example, the administrator of a rogue WLAN may set the SSID of the rogue WLAN to be identical to that of a legitimate WLAN. An unsuspecting user would not be able to distinguish between the SSID of the rogue WLAN and that of the legitimate WLAN, and the user may end up connecting to the rogue WLAN.

Various authentication and/or encryption schemes have been proposed to improve the security of wireless networks. One method of authentication and encryption is to use a public key infrastructure (PM) scheme. This scheme uses two numerical codes, or keys, of which one is referred to as a public key and one is referred to as a private key. Information encrypted using the public key can only be decrypted using the corresponding private key. Public keys can then be exchanged among parties to allow for encrypted information to be sent amongst the parties. Furthermore, digital certificates can be used to verify that a public key belongs to the party claiming to own that particular public key. U.S. Pat. No. 6,321,339 (to French et al.) discloses a system and method for authenticating network users and issuing digital certificates to network users that successfully complete the authentication procedure. The authentication procedure requires the submission of various identifying information, including social security number, home address, phone numbers, and driver's license information. Although French et al. describes the authentication by the network of the individual users of the network, there is no authentication by a user of the network itself.

U.S. Patent Publication No. 2005/0021979 (Wiedmann et al.) discloses a method and system for authentication within a WLAN. A wireless device establishes a connection with an access point of the WLAN, but the wireless device is prevented from further accessing network resources until it has been authenticated. This authentication is performed by the wireless device transmitting identity information to the access point, which in turns transmits the information to an external authentication server for authentication. This authentication can be through digital certificates or a password. As with French et al., Wiedmann et al. provides only for the authentication by the WLAN of a wireless device on the WLAN and not the authentication of the WLAN itself by the wireless device.

U.S. Patent Publication No. 2007/0136596 (Adiletta et al.) discloses a method for authenticating a wireless device on a WLAN using a central controller that can enter a configuration mode through a physical switch. By exchanging messages between the central controller and the wireless device during this configuration mode, the central controller and the wireless device can authenticate each other on the WLAN. However, Adiletta et al. requires a person to physically switch the central controller into the configuration mode before authentication can occur. For WLANs with many wireless devices, it would be time-consuming to have to physically switch the central controller into configuration mode each time a wireless device needs to be authenticated.

### SUMMARY OF THE INVENTION

According to the preferred embodiment of the present invention, there is provided a method for registering a wireless network's identity. The method comprises providing a central server comprising a database, with the central server receiving from the wireless network a request for registration of an identifier. The central server determines whether the identifier is in the database, and an association is created between the identifier and the wireless network if the identifier is not in the database. The association is stored in the database.

In another embodiment, there is provided a method for verifying a wireless network's identity by a wireless device. The method comprises the steps of providing a central server, which is used to register an identifier of a wireless network. The central server receives an authentication request of the identifier from the wireless device, with the authentication request being transmitted through a gateway of the wireless network. The central server then authenticates the identifier.

In yet another embodiment, there is provided a method for verifying a wireless network's identity by a wireless device. The method comprises the steps of the wireless network registering an identifier with a central server; the central server issuing to the wireless network a digital certificate associated with the identifier and the wireless network; the wireless device connecting to a gateway of the wireless network; the gateway transmitting the identifier and the digital certificate to the wireless device; the wireless device connecting to the central server through the gateway; and the wireless device verifying the wireless network's identity with the central server by verifying that the digital certificate corresponds to the identifier of the wireless network.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The present invention will be better understood with reference to the drawings in which:

FIG. 1 is an illustration of the elements of an example WLAN in accordance with an embodiment of the present invention;

FIG. 2 is an illustration of the elements of an example WLAN in accordance with an embodiment of the present invention wherein a rogue access point attempts to mimic an access point of the WLAN;

FIG. 3 is an illustration of the elements of an example WLAN in accordance with an embodiment of the present invention wherein an attacker attempts a “man-in-the-middle” attack; and

FIG. 4 is an illustration of the elements of an example WLAN in accordance with an embodiment of the present invention wherein a hostile wireless device attempts to connect to different WLANs.

### DETAILED DESCRIPTION OF THE DRAWINGS

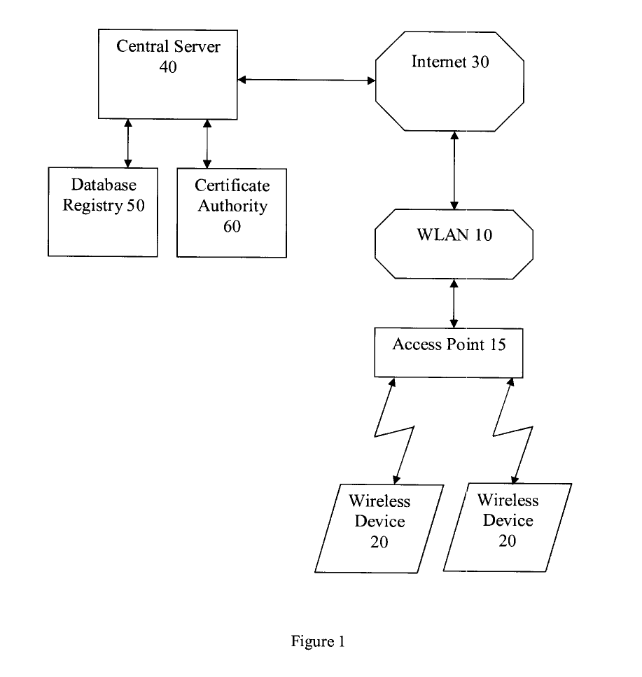

According to the preferred embodiment of the present invention, there is provided a method for the registration and verification of network identifiers of WLANs. Referring to FIG. 1, a WLAN 10 that wishes to register one or more network identifiers communicates, preferably using the Internet 30, to a central server 40. The administrator of the WLAN 10 provides registration information regarding itself, including the desired network identifier(s) and other identifying information, to the central server 40. This identifying information may include physical, technical, or geographical information regarding the WLAN 10. The desired network identifier(s) may comprise one or more alphanumeric strings. In the case of WLANs operating under IEEE 802.11 standards, the network identifier(s) could be one or more SSIDs used by the WLANs.

In addition, the administrator may also provide information relating to the access point(s) 15 or gateway(s) of the WLAN 10 to the central server 40. This information may include information relating to the Internet Protocol (IP) addresses or the Media Access Control (MAC) addresses of the gateway(s) or access point(s) 15 in the WLAN 10.

The central server 40 receives the registration information and connects with a database registry 50 containing all registered network identifiers. In one embodiment, it is not possible to register a network identifier that has already been registered. A check is performed by the central server 40 to ensure that the desired network identifier conforms to the applicable standards for network identifiers for the given wireless standard. For example, there may be restrictions on the length of the allowed network identifiers or restrictions on the type of characters allowed. A check is also performed to ensure that the desired network identifier has not already been registered (either by the WLAN or by some other WLAN). If the desired network identifier has already been registered, the central server 40 communicates this to the WLAN 10 and the registration process is aborted. If the desired network identifier has not been registered, the central server 40 creates an association between the desired network identifier and the WLAN 10. This association is stored in the database registry 50. The central server 40 then transmits the registration information to a certificate authority 60. The certificate authority 60 performs validation of the registration information and if the validation passes, the certificate authority 60 issues one or more digital certificates to the WLAN 10 (through the central server 40) associating the desired network identifier with the WLAN 10. This digital certificate is transmitted to the access point(s) of the WLAN 10.

The digital certificate issued by the certificate authority 60 may be based on the X.509 standard, although modification of the standard may be needed to allow for the incorporation of additional information not currently found in the X.509 standard.

In the preferred embodiment, if information about the individual access points 15 has been provided to the central server, the certificate authority 60 issues a unique digital certificate to each of the access points 15 or gateways of the WLAN 10.

In another embodiment, a network identifier that is identical to a previously registered network identifier can be registered by the WLAN 10, as long as WLAN 10 and the WLAN of the previously registered network identifier are in different geographical areas (e.g. in different countries, in different states, etc.). In such a case, a check is performed to ensure that the desired network identifier has not already been registered in the particular geographical area of the WLAN 10. If this check is successful, the certificate authority 60 performs validation of the registration information and if the validation passes, the certificate authority 60 issues one or more digital certificates associating the desired network identifier with the WLAN 10 and the specific geographical area.

The central server 40 then communicates with the database registry 50 and causes the desired network identifier to be registered in the database of registered network identifiers. The WLAN 10 is then notified of the successful registration of the desired network identifier by the central server 40.

By registering its network identifier, the WLAN 10 can prevent other WLANs from registering the identical network identifier. This ensures that the WLAN 10's network identifier is unique so that users of wireless devices 20 will not be confused as which WLAN 10 they are connecting to when they specify or use a particular network identifier.

When the WLAN 10 is operational, its gateway(s) or access point(s) 15 may wish to broadcast its network identifier so that wireless devices 20 within range of the access point(s) 15 of the WLAN 10 can see the network identifier. Alternatively, the network identifier of the WLAN 10 can be disclosed to users of wireless devices 20 by other means, such as by email or by some other publication means. A wireless device 20 can connect with the access point 15 of WLAN 10 using standard wireless protocols (such as IEEE 802.11). Other encryption standards (such as Wi-Fi Protected Access (WPA) or Wired Equivalent Privacy (WEP) for IEEE 802.11 connections) can additionally be used.

Once the wireless device 20 is connected to the access point of the WLAN 10, the access point 15 of the WLAN 10 transmits a digital certificate to the wireless device 20. In the case where each access point of the WLAN 10 has been issued a unique digital certificate, the access point 15 transmits its unique digital certificate to the wireless device 20. In the case where each access point 15 of the WLAN has been issued the same digital certificate, the access point 15 transmits this digital certificate to the wireless device 20.

The wireless device 20 is allowed to connect, preferably through the Internet, to the central server 40 through the access point 15 of the WLAN 10, but is prevented from accessing any other resources on the WLAN 10. Preferably, this is done by using software implementing a captive portal on the access point 15 of the WLAN 10 or by using a firewall. When the wireless device 20 connects to the central server 40, the wireless device 20 transmits information relating to the digital certificate and the purported network identifier of the WLAN 10 to the central server. The wireless device 20 may also transmit other information to the central server 40, such as traceroute information or information relating to the Internet Protocol addresses of the access point 15 and the wireless device 20. The central server 40 can authenticate the digital certificate and verify that the purported network identifier is indeed associated with the WLAN 10. This ensures that the WLAN 10 to which the wireless device 20 is connecting to is the one to which the wireless device 20 is intending to connect. In the case where each access point 15 of the WLAN has been issued a unique digital certificate, the central server 40 can also authenticate the unique digital certificate to ensure that the access point to which the wireless device 20 is connecting to is indeed part of the WLAN 10.

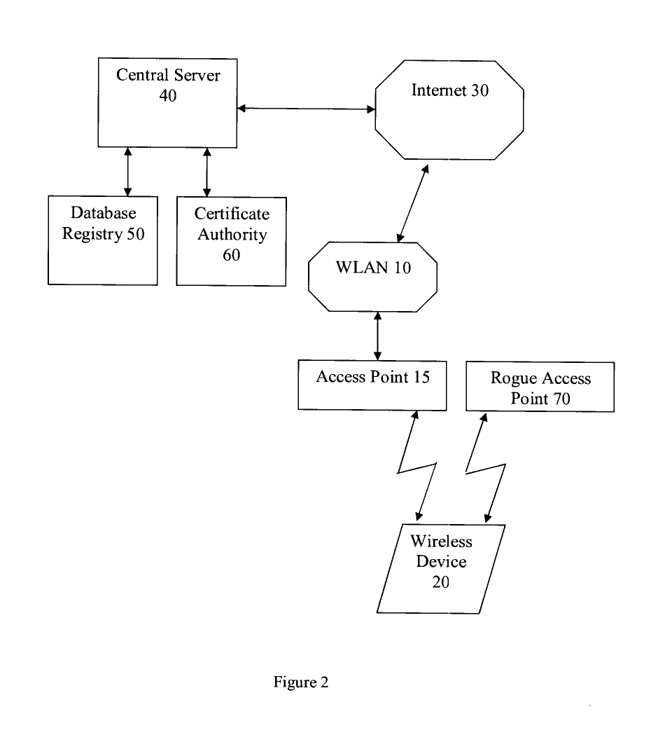

Referring to FIG. 2, when a rogue access point 70 attempts to mimic the network identifier of the WLAN 10 and trick users of wireless device 20 into connecting to it instead of the (legitimate) access point 15, the rogue WLAN 70 may be broadcasting the identical network identifier as that of the (legitimate) access point 15 of the WLAN 10. However, the wireless device 20 that connects with the rogue access point 70 would not be sent the digital certificate of the WLAN 10 (or the access point 15) or would be given an invalid digital certificate by the rouge access point 70. After connecting to the central server 40, the central server 40 would alert the wireless device 20 that the rogue access point 70 is unregistered or that the digital certificate is invalid. This can be performed either by software running on the central server 40 or by software running on the wireless device 20. The user can then take appropriate steps to disconnect from the rogue access point 70 and reconnect with the appropriate (registered) access point 15.

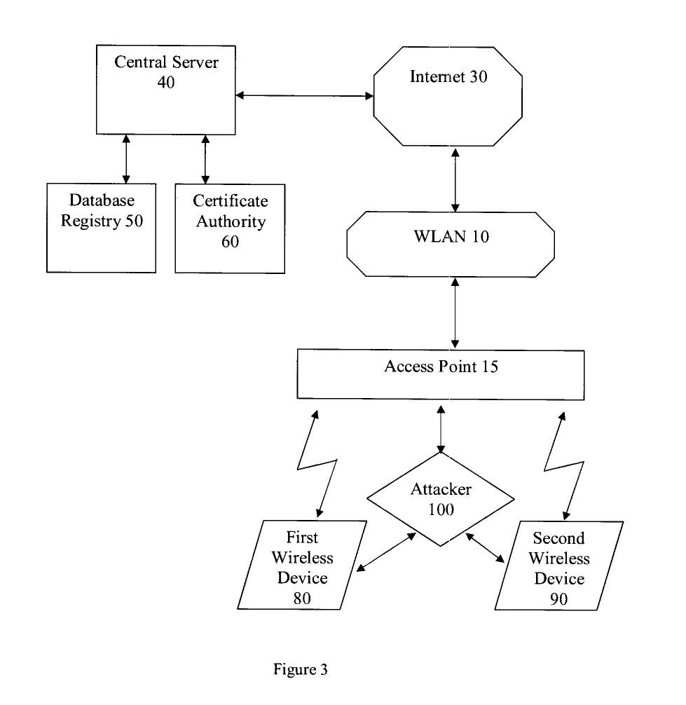

FIG. 3 depicts a “man-in-the-middle” attacker where an attacker 100 attempts to read, insert, intercept, or modify information sent between two wireless devices 80 and 90 or between a wireless device and the network. The attacker 100 may try to intercept information sent by the first wireless device 80 by pretending to be an access point of the WLAN 10. If the first wireless device 80 connects to the attacker 100 instead of the access point 15, then any data sent or received by the first wireless device 80 may be deleted, modified, or accessed. The attacker 100 may attempt to mimic access point 15 by forwarding the digital certificate of access point 15 to the first wireless device 80 when the first wireless device 80 attempts to connect to the attacker 100. However, when the first wireless device 80 connects to the central server 40 to authenticate the digital certificate, traceroute information between the first wireless device 80 and the network is also sent to the central server 40. The central server 40 detects that the traceroute information includes an extra “hop” between the first wireless device 80 and the access point 15 and alert the first wireless device 80 of the possible “man-in-the-middle”.

In another embodiment of the invention, wireless devices 20 can also be registered in the database registry 50 through the central server 40. This registration process may be performed automatically by software installed on the wireless device 20 or central server 40, or by a user inputting data to the central server 40. The wireless device 20 connects with the central server 40 (preferably via the Internet 30 through a WLAN or by some other network connection) and provides the central server 40 with registration information regarding itself. This registration information may include information such as the MAC address of the wireless device 20, identification information regarding the owner of the wireless device 20, and other physical identification of the wireless device 20. The central server 40 communicates this information to the certificate authority 60, which performs validation of the registration information. If validation is successful, the certificate authority 60 issues a digital certificate to the wireless device 20 (through the central server 40). The registration information is then stored in the database registry 50 by the central server 40.

Once the wireless device 20 has been registered and a digital certificate has been issued, the wireless device can connect to a WLAN as before. A WLAN may require that a wireless device 20 be authenticated before the wireless device 20 is allowed to access network resources. For example, the WLAN 10 may request authentication information from the wireless device 20. The wireless device 20 may provide its digital certificate to the WLAN 10 to confirm the identity of the wireless device 20. The WLAN 10 can then connect with the central server 40 and authenticate the digital certificate. Additionally, the WLAN 10 may provide its digital certificate to the wireless device 20 and allow the wireless device 20 to connect with the central server 40 to confirm the identity of the WLAN 10. The authentication procedures may be implemented by software running on the wireless device 20 and on the computers administrating the WLAN 10. Once authentication has been successfully completed, the wireless device 20 may be granted full access to the network resources of the WLAN 10. If the wireless device 20 is not registered or is unable to produce a valid digital certificate, the WLAN 10 may restrict the access granted to the wireless device 20 until appropriate authentication is completed.

In other situations, the WLAN 10 may not require that all wireless devices on its network be registered. However, the WLAN 10 may flag any unregistered wireless devices for increased scrutiny or set different access privileges to wireless devices depending on whether the wireless devices are registered.

Even for WLANs that do not require wireless devices on it to be registered before allowing access, the registration of wireless devices provides some level of security. Referring again to FIG. 3, the first wireless device 80 has registered with the central server 40 and can communicate with the central server 40. The first wireless device 80 is able to collect various network information, including the identities of wireless devices within range (e.g. the second wireless device 90 and the attacker 100) and the network identifier of the WLAN 10. This information is communicated via the Internet 30 to the central server 40, which may perform verification on the WLAN 10 and the wireless devices detected by the first wireless device 80. This verification may be done by the central server 40 examining the digital certificates, if any, of the WLAN 10 and of the wireless devices detected by the first wireless device 80. The central server 40 communicates to the first wireless device 80 information regarding the verification of the detected wireless devices. If there are one or more wireless devices that the central server 40 is unable to verify, the first wireless device 80 is alerted to this. This alerts the first wireless device 80 that there could one or more attackers conducting attacks on the first wireless device 80. For example, in the example shown in FIG. 3, if both wireless devices 80 and 90 had been previously registered with the central server 40, the first wireless device 80 would be notified of that fact. However, if the attacker 100 has not registered with the central server 40, the first wireless device 80 would be notified that an unregistered device is within range of the first wireless device 80. The user of the first wireless device 80 can then take any necessary precautions to reduce the risk of attack.

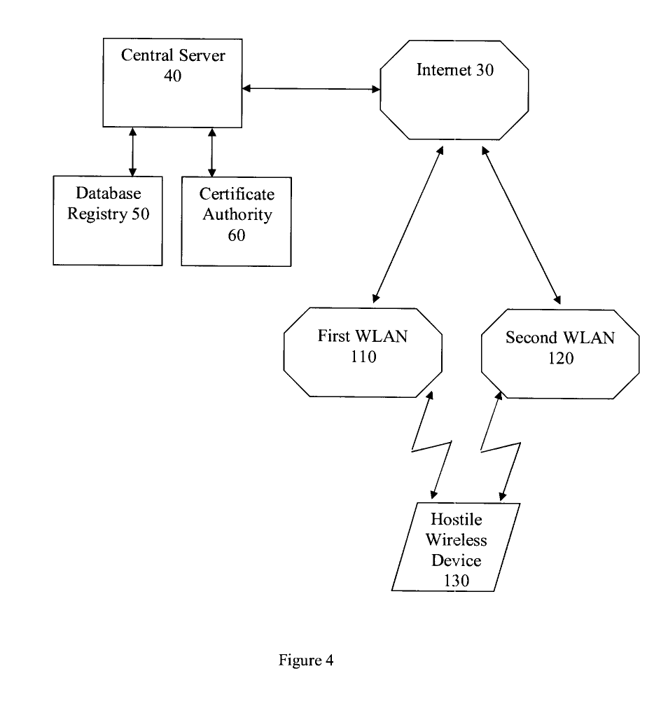

In another embodiment of the present invention, security is enhanced across different WLANs. Referring to FIG. 4, a first WLAN 110 that detects that one of the wireless devices on its network is conducting malicious activity may flag the hostile wireless device 130 and communicate (such as through the Internet 30) with the central server 40 any identifying information regarding the hostile wireless device 130. This information may include the MAC address of the hostile wireless device 130 and the nature of the malicious activity conducted by the hostile wireless device 130. The information may then stored by the central server 40 in the database registry 50. The first WLAN 110 can then take any appropriate action it deems fit, such as disconnecting the hostile wireless device 130 from its network.

Subsequently, when the hostile wireless device 130 attempts to connect wirelessly to a second WLAN 120, the second WLAN 120 may request various identifying information from the hostile wireless device 130 (such as the MAC address of the hostile wireless device 130 or other identification) as part of its standard authentication procedure. After this information is communicated from the hostile wireless device 130 to the second WLAN 120, the second WLAN 120 contacts the central server 40 (such as through the Internet 30) to request verification on the hostile wireless device 130. The central server 40 retrieves the relevant information from the database registry 50 and is able to determine that the hostile wireless device 130 has been previously flagged as conducting malicious activity on the first WLAN 110. This information is communicated by the central server 40 to the second WLAN 120, which can then take the appropriate steps to deal with the hostile wireless device 130. This may include the second WLAN 120 denying access by the hostile wireless device 130 to its network or restricting the access privileges of the hostile wireless device 130.

In another embodiment of the invention, when a WLAN 10 or a wireless device 20 registers with the central server 40, a unique username and a password is produced for the registering WLAN 10 or wireless device 20. This username and password can be used a means of identification when the WLAN 10 or the wireless device 20 attempts to later communicate with the central server 40 to access information from the central server 40.

The central server 40 may also provide a graphical user interface to allow the administrators of registered WLANs or the users of registered wireless devices to access information from the central server 40 in a user-friendly manner. The graphical user interface may allow administrators and users to register new WLANs and new wireless devices or to manage existing registrations.

The techniques described above may also be employed by a WISP instead of a WLAN. A WISP is a public type of WLAN that allows wireless devices to connect to the WLAN and have access to the Internet.

It will be appreciated by those skilled in the art that the preferred and alternative embodiments have been described in some detail but that certain modifications may be practiced without departing from the principles of the invention.

What is claimed:

1. A method for registering a wireless network's identity, said method comprising the steps of:
providing a central server comprising a database;
said central server receiving from said wireless network a request for registration of an identifier of said wireless network;
said central server determining whether said identifier is in said database;
said central server creating an association between said identifier and said wireless network if said identifier is not in said database; and
said central server storing said association in said database.

2. The method of claim 1, wherein said identifier is a service set identifier.

3. The method of claim 1, wherein said central server further comprises a digital certificate authority.

4. The method of claim 3, further comprising the step of said central server issuing a digital certificate to said wireless network, said digital certificate comprising information relating to said association.

5. The method of claim 4, further comprising the steps of:
said central server receiving from said wireless network a request for registration of one or more gateways of said wireless network;
said central server issuing a unique digital certificate to each of said gateways, said unique digital certificate comprising information relating to said association and relating to particular said gateway.

6. A method for verifying a wireless network's identity by a wireless device, said method comprising the steps of:
providing a central server;
registering by said central server an identifier of a wireless network;
receiving by said central server an authentication request of said identifier from said wireless device, said authentication request transmitted through a gateway of said wireless network; and
authenticating by said central server of said identifier.

7. The method of claim 6, wherein said identifier is a service set identifier.

8. The method of claim 6, wherein said central server comprises a database and a digital certificate authority.

9. The method of claim 8, wherein said step of registering by said central server an identifier of a wireless network comprises:
creating an association between said identifier and said wireless network;
storing said association in said database; and
issuing by said digital certificate authority a digital certificate to said wireless network, said digital certificate comprising information relating to said association.

10. The method of claim 9, wherein said authentication request comprises said digital certificate and said identifier.

11. The method of claim 10, wherein said step of authenticating by said central server of said identifier comprises validating said digital certificate with said identifier.

12. The method of claim 8, wherein said step of registering by said central server an identifier of a wireless network comprises:
creating an association between said identifier and said wireless network;
storing said association in said database;
receiving information from said wireless network relating to one or more gateways of said wireless network; and
issuing by said digital certificate authority a unique digital certificate to each gateway, said unique digital certificate comprising information relating to said association and relating to particular said gateway.

13. The method of claim 12, wherein said authentication request comprises said unique digital certificate and said identifier.

14. The method of claim 13, wherein said step of authenticating by said central server of said identifier comprises validating said unique digital certificate with said identifier and said gateway.

15. A method for verifying a wireless network's identity by a wireless device, said method comprising the steps of:
said wireless network registering an identifier of said wireless network with a central server;
said central server issuing a digital certificate to said wireless network, said digital certificate being associated with said identifier and said wireless network;
said wireless device connecting to a gateway of said wireless network;
said gateway transmitting said identifier and said digital certificate to said wireless device;
said wireless device connecting to said central server through said gateway; and
said wireless device verifying said wireless network's identity with said central server by verifying that said digital certificate corresponds to said identifier of said wireless network.

16. The method of claim 15, wherein said identifier is a service set identifier.

17. The method of claim 15, further comprising the step of said wireless network transmitting information to said central server comprising identifying information of said wireless device.

18. The method of claim 17, wherein said identifying information comprises the Internet Protocol address of said wireless device.

19. The method of claim 17, wherein said identifying information comprises the Media Access Control address of said wireless device.

20. The method of claim 17, further comprising the step of said central server flagging said identifying information if said wireless network identifies said wireless device as acting maliciously.

21. The method of claim 20, further comprising the step of said central server transmitting an alert to said wireless network if said identifying information of said wireless device has been previously flagged by said central server.

22. The method of claim 15, wherein the step of said wireless device connecting to said central server through said gateway further comprises the step of said gateway blocking all other network connections by said wireless device through said gateway.

23. The method of claim 22, wherein said step of said gateway blocking all other network connections is done using a captive portal.

24. The method of claim 22, wherein said step of said gateway blocking all other network connections is done using a firewall.
